(19) United States
(12) Patent Application Publication
(10) Pub. No.: US 2026/0308951 A1
(43) Pub. Date: Oct. 8, 2026

(54) VEHICLE LOCK WITH U-SHAPED RELEASE LEVER

(71) Applicant: CEBI ITALY S.P.A., DRONERO (CN) (IT)

(72) Inventors: Simone DI CORI, CASTELFIDARDO (AN) (IT); Eugenio Guglielmo D'URSO, OSIMO (AN) (IT)

(21) Appl. No.: 19/481,480

(22) PCT Filed: Jul. 29, 2024
(86) PCT No.: PCT/IB2024/057307

§ 371 Date: Nov. 4, 2025

(30) Foreign Application Priority Data
Aug. 30, 2023 (IT) 102023000017790

(51) Int. Cl. E05B 81/14; E05B 81/06; E05B 81/30; E05B 81/34; E05B 81/44; E05B 81/90

(52) U.S. Cl. CPC E05B 81/14; E05B 81/06; E05B 81/30; E05B 81/34; E05B 81/44; E05B 81/90

(57) ABSTRACT

A vehicle lock comprises a box, a catch that engages a striker, a pawl suitable for locking the catch, a release lever suitable for cooperating with the pawl to unlock the catch, and an actuator that moves a gear train configured to move the release lever. The release lever is in the form of a U-shaped bracket comprising a side arm connected to a lower arm and to an upper arm revolvingly mounted on a first shaft supporting a gear that moves the release lever. The side arm of the release lever is suitable for engaging with a seat of the pawl to move the pawl towards the unlocked position.

### DESCRIPTION

The present invention relates to a lock for a vehicle hatch, specifically for the trunk of a vehicle.

Vehicle locks suitable for locking a striker that is integral with a body part or a hatch of a vehicle are known.

WO2021/121883A1 describes such a type of lock. Such a lock comprises:
a box comprising a base plate with a slot suitable for receiving a striker,
a catch suitable for moving to a closing position wherein the striker is locked, and
a pawl suitable for locking the catch in the closing position.

Two actuators arranged on the outside of the box operate the pawl in order to open the lock.

In the automotive market there is a demand for locks with a single actuator that is integral in the box of the lock. In such a case, a gear train connects the motor of the actuator to levers of the lock. However, if the motor is jammed, when the catch is in the closing position, the opening of the lock becomes complicated. US2018087298A1 describes a lock with an actuator that is integral into the box of the lock. To close the lock, the actuator operates a motorized locking lever that locks the catch. To open the lock, the actuator operates a motorized release lever that unlocks the pawl, releasing the catch. The lock comprises a manual release lever that disengages the gears of the actuator and moves the motorized locking lever. Such a system is impaired by drawbacks due to the presence of the motorized locking lever and to the fact that the manual release lever directly operates on the motorized locking lever.

US2016312499A1 describes a lock with a motorized locking mechanism comprising a manual release lever that moves between two points along an axis of rotation.

EP4180597A1 describes a lock with a single actuator in the lock box and a lifting system of the primary gear.

DE102021123328A1 describes a vehicle lock comprising a locking device with a rotary lock and a pawl for locking the rotary lock and a revolving release lever.

The purpose of the present invention is to eliminate the drawbacks of the prior art by providing a vehicle lock that is provided with an actuator disposed in the box of the lock and a movement system of the pawl that is efficient, safe, reliable, versatile, space-saving, and simple to operate.

These purposes are achieved in accordance with the invention with the features of the independent claim 1.

Advantageous achievements of the invention appear from the dependent claims.

The lock according to the invention is defined in claim 1.

Further features of the invention will appear clearer from the following detailed description, which refers to a purely illustrative and therefore non-limiting embodiment, illustrated in the appended drawings, wherein:

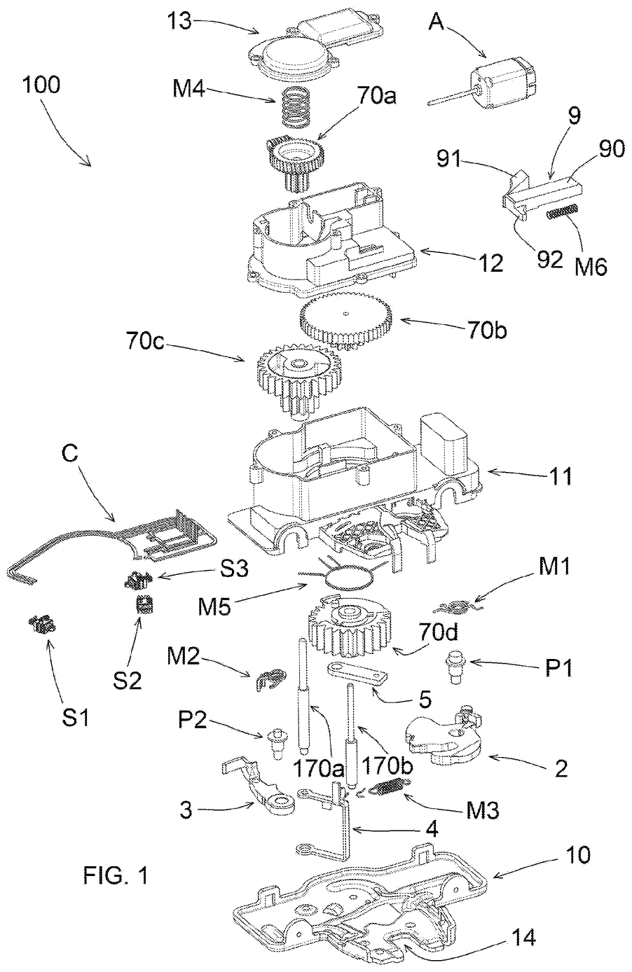

FIG. 1 is an exploded perspective view of the parts of the lock according to the invention;

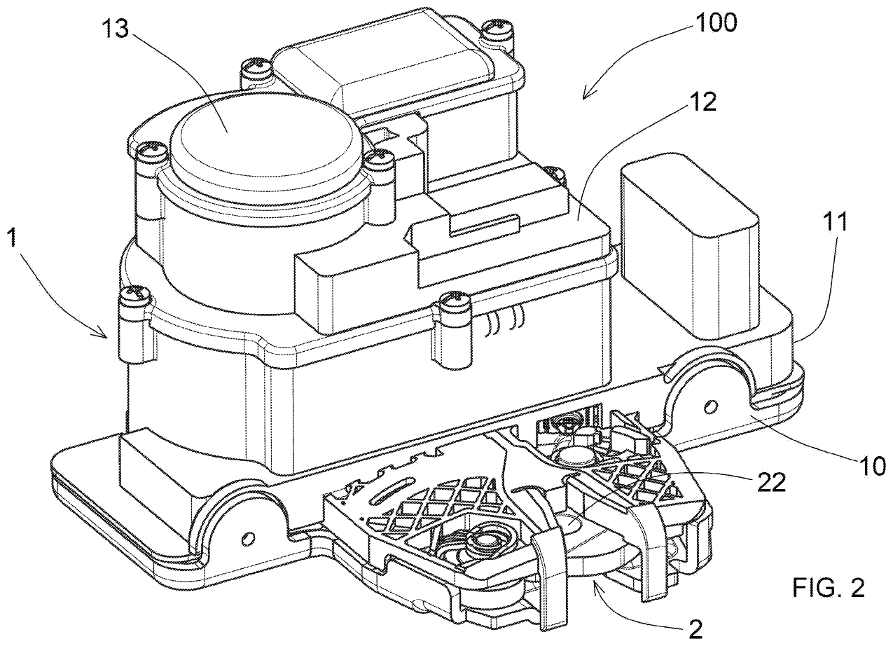

FIG. 2 is a perspective view of the lock of FIG. 1 in assembled condition;

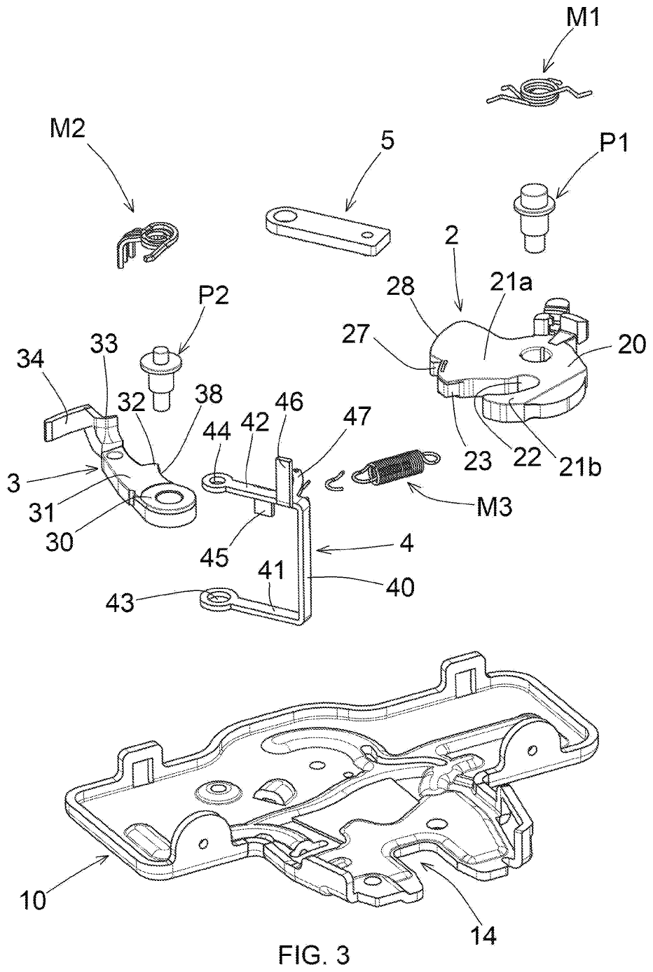

FIG. 3 is an exploded perspective view of some parts of the lock of FIG. 1;

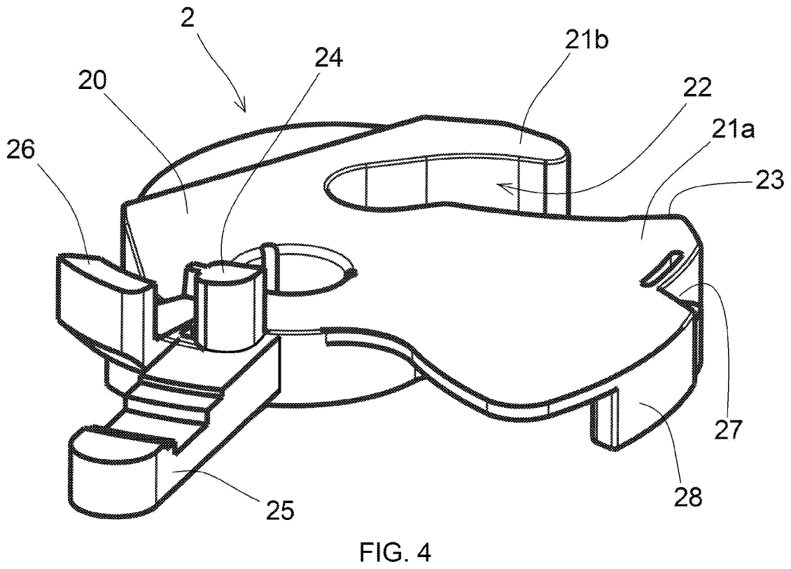

FIG. 4 is a perspective view of the catch of the lock according to the invention;

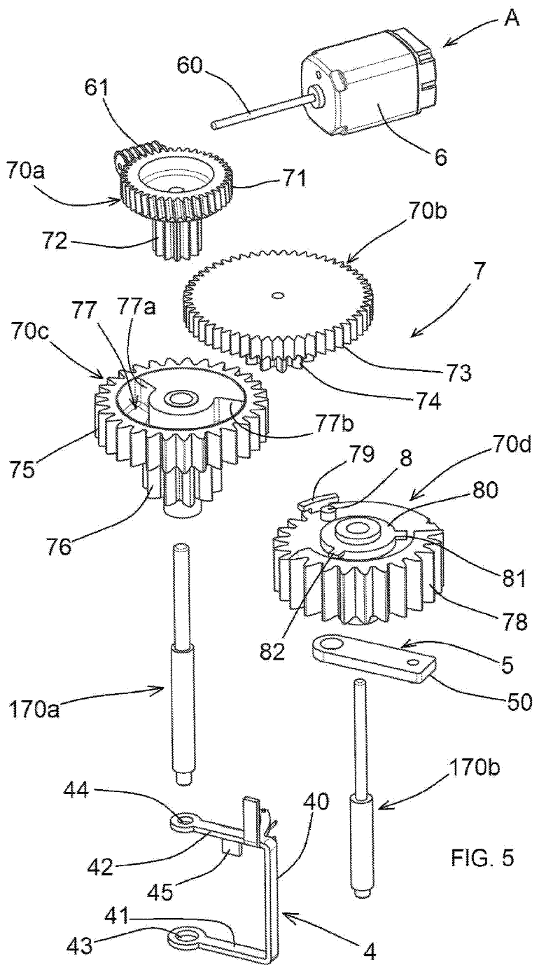

FIG. 5 is an exploded perspective view of the actuator, the gear train, the release lever, and the closing lever of the lock of FIG. 1;

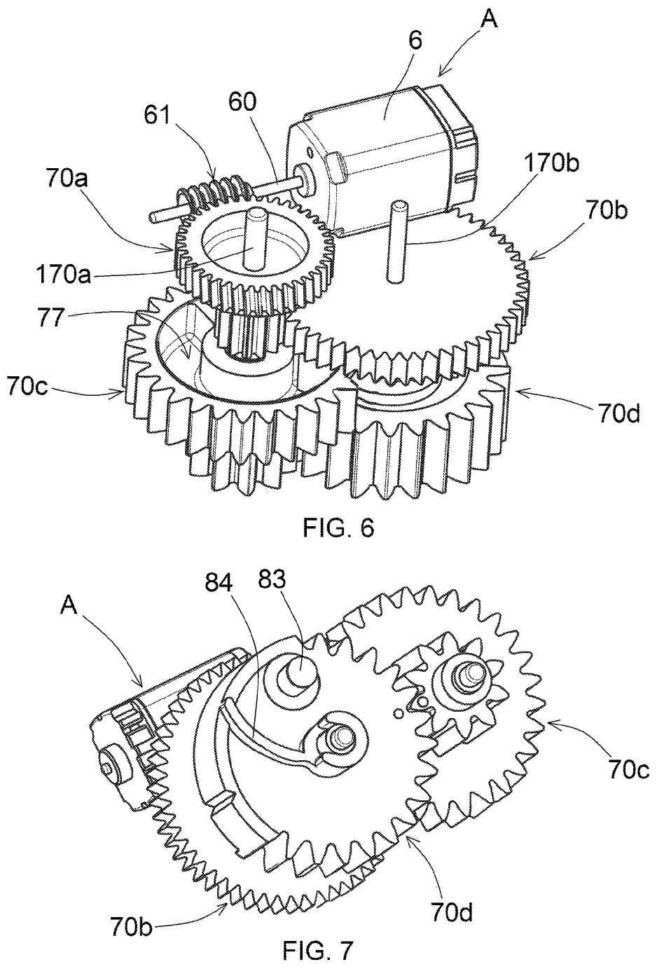

FIG. 6 is a perspective top view of an assembly comprising the actuator and the gear train in assembled condition;

FIG. 7 is a perspective bottom view of the assembly in FIG. 6;

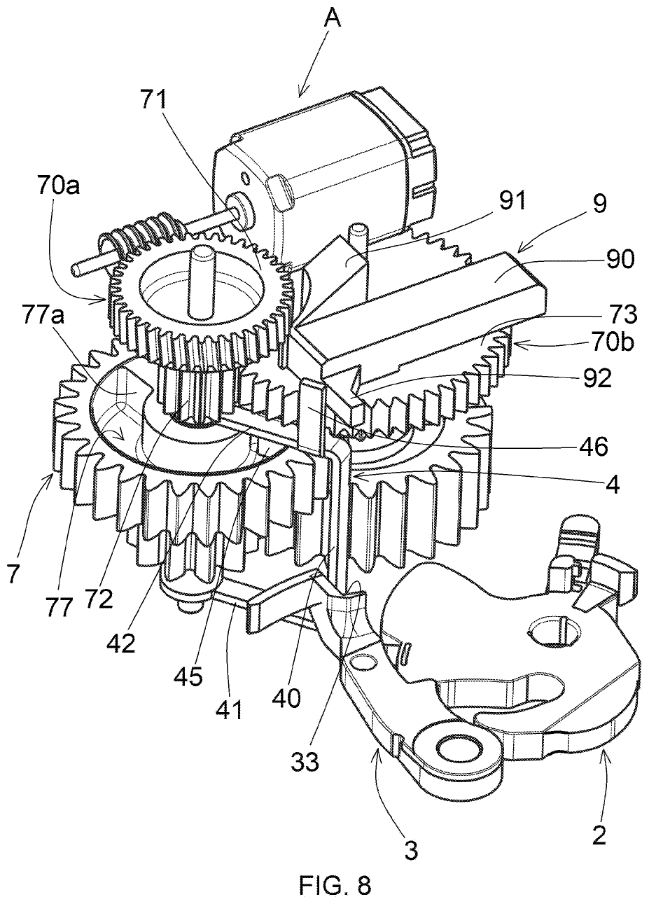

FIG. 8 is the same view as FIG. 6, with the addition of the release lever, the pawl and the catch;

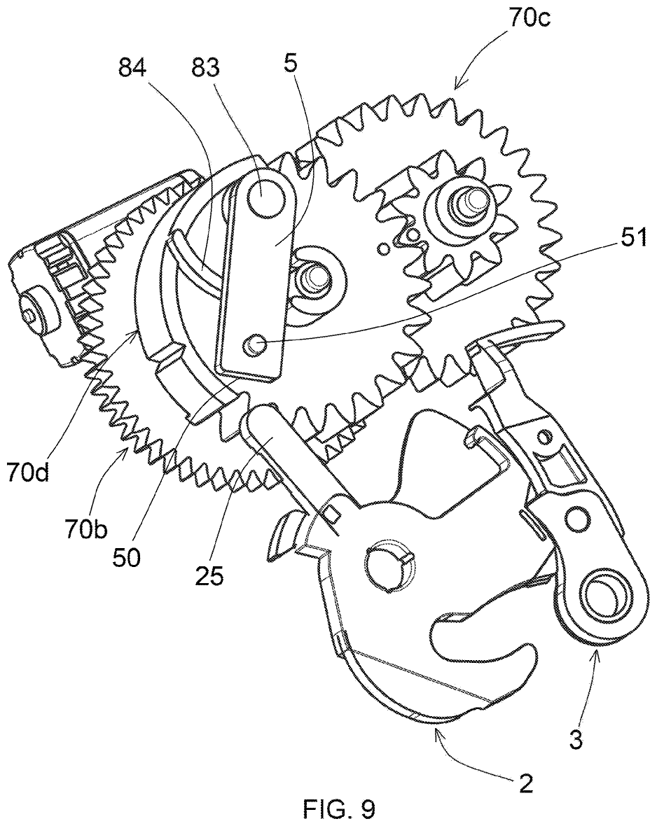

FIG. 9 is the same view as FIG. 7, with the addition of the closing lever;

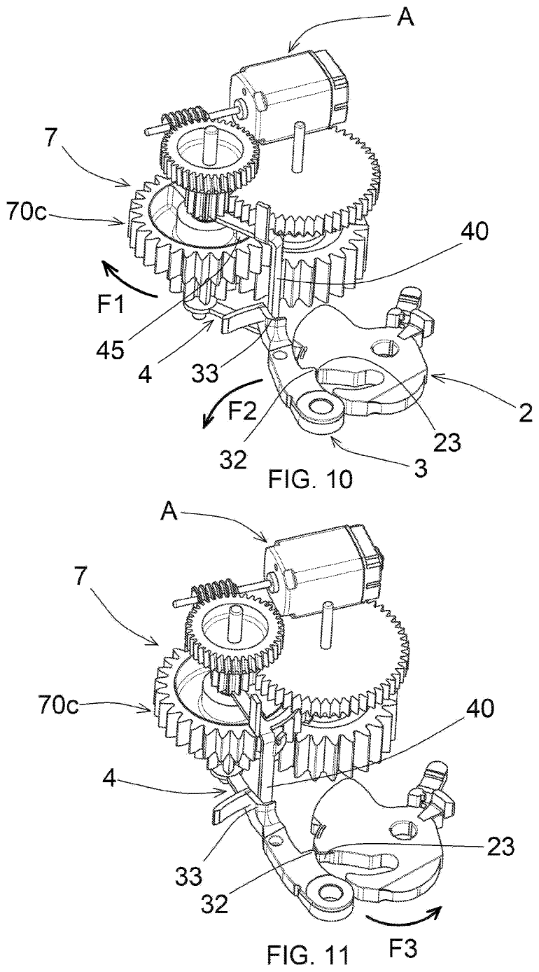

FIG. 10 is a perspective view of some parts of the lock in assembled condition, when the lock is in closing position;

FIG. 11 is the same view as FIG. 10, during an opening step of the lock;

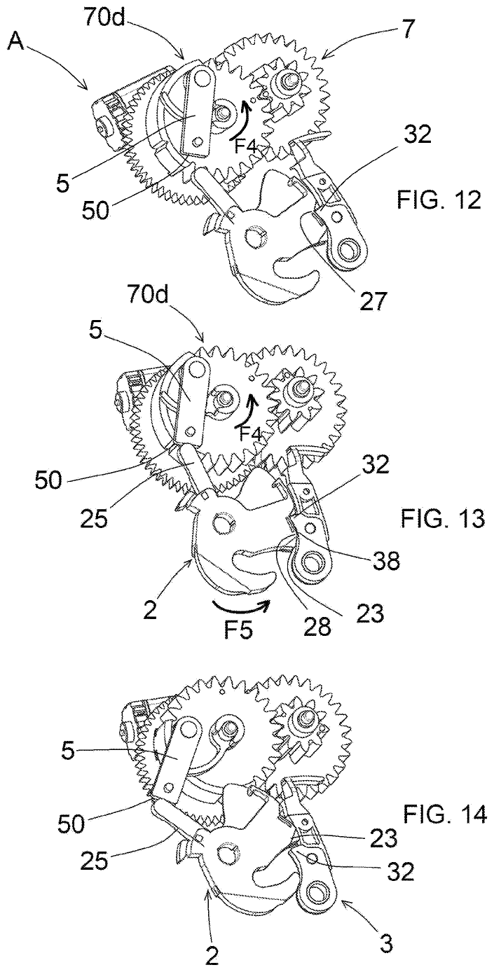

FIG. 12 is the same view as FIG. 11, but seen from an opposite side, with the catch in an intermediate closing position;

FIG. 13 is the same view as FIG. 12, when the catch is moving from the intermediate closing position to the closing position;

FIG. 14 is the same view as FIG. 12, with the catch in closing position;

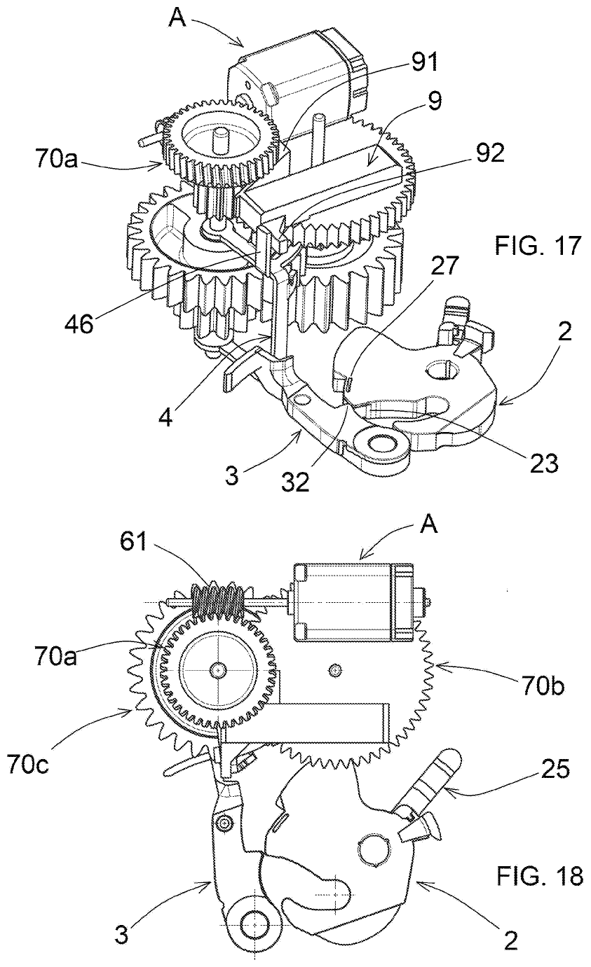

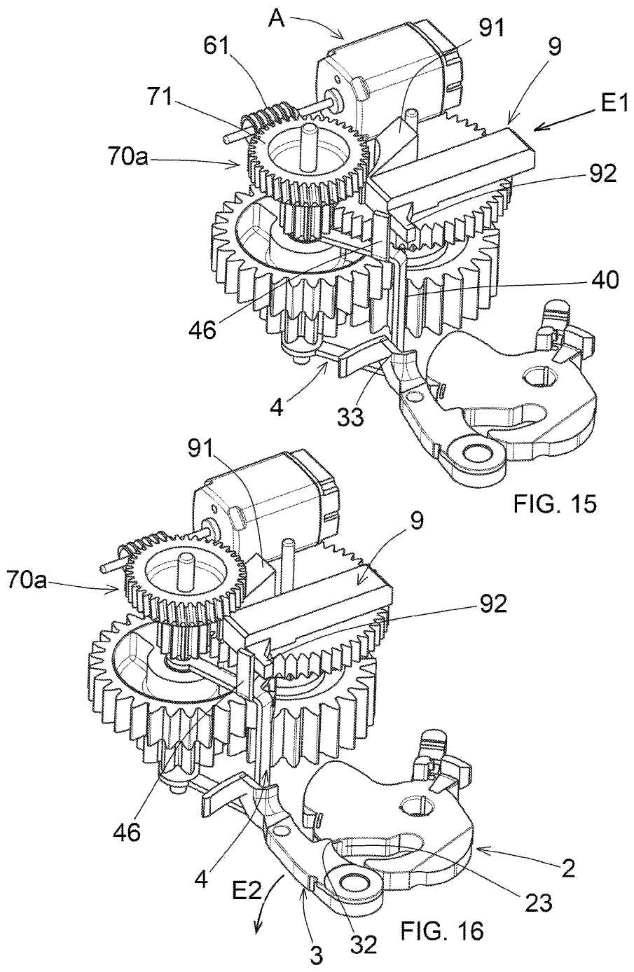

FIG. 15 is the same view as FIG. 10, with the addition of the emergency lever, illustrating an initial situation in which the lock is closed;

FIG. 16 is the same view as FIG. 15, illustrating a situation in which the emergency lever has been operated;

FIG. 17 is the same view as FIG. 15, illustrating a situation after the operation of the emergency lever;

FIG. 18 is a view of the parts of the lock of FIG. 17, after the operation of the emergency lever; and

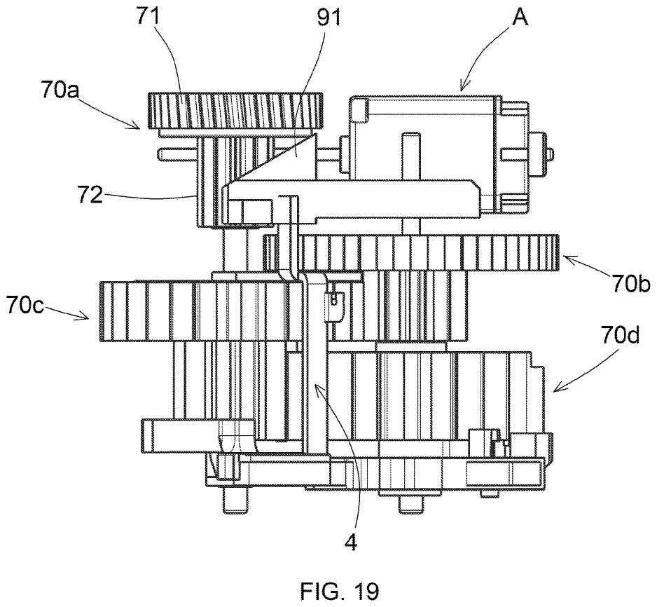

FIG. 19 is a side view of the parts of the lock of FIG. 17, after the operation of the emergency lever.

With the aid of the Figures, a lock according to the invention is described, which is comprehensively indicated with reference numeral 100.

With reference to FIGS. 1 and 2, the lock (100) comprises a box (1) comprising a base plate (10), a first intermediate body (11), a second intermediate body (12) and a cover (13).

A catch (2) and a pawl (3) are pivoted onto the base plate (10).

The base plate (10) comprises a U-shaped slot (14) suitable for receiving a striker (not shown in the figures). The lock (100) may be integral to the vehicle body and the striker may be integral to the hatch or vice versa.

A first pivoting pin (P1) and a second pivoting pin (P2) are arranged in the base plate (10) to pivot the catch (2) around a first pivoting axis and the pawl (3) around a second pivoting axis. The two pivoting axes are parallel to each other and orthogonal to the base plate (10).

Referring to FIGS. 3 and 4, the catch (2) has a plate-like shape that comprises a central portion (20) arranged around the first pivoting pin (P1). A first arm (21a) and a second arm (21b) protrude from the central portion (20) of the catch so as to define a U-shaped engagement seat (22) for engaging the striker when it is in the slot (14) of the base plate in order to close the lock.

A stop tooth (23) is arranged in the first arm (21a) of the catch opposite the engagement seat (22).

A stop seat (27) is arranged on the first arm (21a) outside the engagement seat (22).

The catch (2) comprises a curved cam surface (28) that ends in the stop seat (27).

A spring-holding pin (24) protrudes from the central portion (20) in distal position relative to the engagement seat (22) to retain one end of a first spring (M1) that is attached to the box (1).

The catch (2) has an operating arm (25) that protrudes radially from the central portion (20) in a direction opposite to the engagement seat (22).

The catch has a protrusion (26) that protrudes from the central portion (20) near the operating arm (25) and the spring-holding pin (24)

The catch (2) can rotate around the first pivoting axis of the first pivoting pin (P1) to go from a closing position, wherein the striker is locked, to an open position, wherein the striker is released.

The first spring (M1) stresses the catch (2) toward its open position.

The pawl (3) comprises a central portion (30) arranged around the second pivoting pin (P2). An arm (31) protrudes from the central portion (30) of the pawl. A stop tooth (32) is provided on the arm (31) of the pawl. The stop tooth (32) of the pawl is suitable for going in contact against the stop tooth (23) of the catch arranged in the first arm (21a) of the catch in order to lock the catch (2) in the closing position.

The stop tooth (32) of the pawl is suitable for engaging the stop seat (27) of the catch so as to lock the catch (2) in an intermediate closing position.

The arm (31) of the pawl has a curved cam surface (38) that cooperates with the cam surface (28) of the catch.

The arm (31) of the pawl has a seat (33).

A lever (34) protrudes from the arm (31) of the pawl behind the seat (33).

The pawl (3) can rotate about the second pivoting axis of the second pivoting pin (P2) in order to go from a locked position, wherein the catch (2) is locked, to an unlocked position, wherein the catch (2) is released.

A second spring (M2) is arranged around the second pivoting pin (P2). The second spring has a first end in contact with the pawl (3) and a second end in contact with the box (1). The second spring (M2) stresses the pawl (3) toward the locked position.

The lock (100) comprises a release lever (4) that operates the pawl (3) to move the pawl (3) toward the unlocked position.

The release lever (4) is shaped like a U-shaped bracket comprising a side arm (40) connected to a lower arm (41) and to an upper arm (42). The side arm (40) of the release lever (4) is suitable for engaging with the seat (33) of the pawl in order to move the pawl (3) toward the release position.

The lower arm (41) and the upper arm (42) terminate in respective eyelets (43, 44).

A first protrusion (45) protrudes inferiorly from the upper arm, a second protrusion (46) protrudes superiorly from the upper arm, and a third protrusion (47) protrudes laterally from the upper arm. The third protrusion (47) on the upper arm is a spacer used to prevent the toothing of the secondary gear (70b) from creating a collision between the teeth and the edge of the release lever (4).

A third spring (M3) is a return spring of the release lever (4) that is used to return the release lever (4) to its idle position when the lock is released.

The lock (100) comprises a closing lever (5) that cooperates with the operating arm (25) of the catch (2) to move the catch from the intermediate closing position to the closing position.

Referring to FIGS. 5, 6, and 7, the release lever (4) is moved by an actuator (A) by means of a gear train (7) that moves the release lever (4) from its initial idle position to its operating position in which it engages the seat (33) of the pawl.

The actuator (A) comprises an electric motor (6) having a drive shaft (60) on which a worm gear (61) is keyed.

The gear train (7) comprises:
a primary gear (70a) meshing with the worm gear (61),
a secondary gear (70b) meshing with the primary gear (70a),
a tertiary gear (70c) meshing with the secondary gear (70b), and
a quaternary gear (70d) meshing with the tertiary gear.

The primary gear (70a) has a first toothed wheel (71) with helical teeth that meshes with the worm gear (61) and a second toothed wheel (72) with straight teeth. The first toothed wheel (71) has a larger diameter than the second toothed wheel (72).

The primary gear (70a) is mounted on a first shaft (170a) mounted in the base plate (10). A fourth spring (M4) (FIG. 1) is arranged on the primary gear (70a) under the cover (13) so as to push the primary gear (70a) down.

The secondary gear (70b) comprises a first toothed wheel (73) with straight teeth that meshes into the second toothed wheel (72) of the primary gear and a second toothed wheel (74) with straight teeth. The second toothed wheel (74) has a smaller diameter than the first toothed wheel (73).

The secondary gear (70b) is mounted on a second shaft (170b) that is mounted on the base plate (10).

The tertiary gear (70c) comprises a first toothed wheel (75) with straight teeth that meshes into the second toothed wheel (74) of the primary gear and a second toothed wheel (76) with straight teeth. The second toothed wheel (76) has a smaller diameter than the first toothed wheel (75).

The first toothed wheel (75) of the tertiary gear is provided with a curved seat (77) in the shape of an arc of a circle subtended by an angle at the center of about 160°-200°. The curved seat (77) of the tertiary gear has two stop surfaces (77a, 77b). The curved seat (77) of the tertiary gear is suitable for accommodating the first protrusion (45) of the release lever.

The tertiary gear (70c) is mounted on the first shaft (170a) below the primary gear (70a).

With reference to FIG. 1, it should be noted that the actuator (A) and the primary gear (70a) are mounted between the second intermediate body (12) and the cover (13) of the box; the secondary gear (70b) and the tertiary gear (7c) are mounted between the first intermediate body (11) and the second intermediate body (12) of the box; and the quaternary gear (70d) is mounted between the base plate (10) and the first intermediate body (11) of the box. In view of the above, the actuator (A) and the gear train (7) are contained in the box (1) that encloses the lock.

As shown in FIG. 8, the release lever (4) is moved by the tertiary gear (70c). The eyelets (43, 44) of the lower and upper arms (41, 42) of the release lever are revolvingly mounted on the first shaft (170a), and the lower and upper arms (41, 42) of the release lever are arranged below and above the tertiary gear (70c) so that the side arm (40) of the release lever is located in lateral position relative to the tertiary gear (70c) in order to cooperate with the seat (33) of the pawl. The first protrusion (45) of the release lever is located in the curved seat (77) of the tertiary gear.

The quaternary gear (70d) comprises a toothed wheel (78) with straight teeth that extends for an arc of a circle of 250° to 290°. The toothed wheel (78) of the quaternary gear meshes with the second toothed wheel (76) of the tertiary gear.

Referring to FIG. 5, the quaternary gear (70d) is provided on its upper surface with a hook (79) in peripheral position, an upper pin (8) near the hook (79) and a discoidal tang (80) with two radial projections (81, 82).

The hook (79), the upper pin (8) and the discoidal tang (80) are used to realign the quaternary gear (70d) to its initial idle position by means of the fifth spring (M5). The radial projections (81, 82) of the discoidal tang (80) ensure the retention of the fifth spring (M5) in its seat.

Referring to FIG. 1, a fifth spring (M5) is arranged between the quaternary gear (70d) and the box (1). The fifth spring (M5) is hooked onto the hook (79) of the quaternary gear.

Referring to FIG. 7, the quaternary gear (70d) is provided on its lower surface with a lower pin (83) in peripheral position and with a comma-shaped rib (84) that extends radially from a central position to a peripheral position.

Referring to FIG. 8, the lock (100) comprises an emergency lever (9) suitable for being manually operated by an operator to unlock the lock in the event that the actuator (A) fails or the lock is jammed.

The emergency lever (9) comprises a body (90) in the shape of a parallelepiped. An inclined plane (91) and an operating tooth (92) are connected to the body (90) of the emergency lever and protrude from either side of the body (90).

When the emergency lever (9) is in idle position, as shown in FIG. 8, the inclined plane (91) is opposite the first toothed wheel (71) of the primary gear (70a) and the operating tooth (92) is opposite the second protrusion (46) of the release lever (4).

In view of the above, when the user pushes the emergency lever (9), the inclined plane (91) advances under the first toothed wheel (71) of the primary gear and lifts the primary gear (70a), disengaging the first toothed wheel (71) of the primary gear from the worm gear (61) of the actuator and the second toothed wheel (72) of the primary gear from the first toothed wheel (73) of the secondary gear. In this way, the primary gear (70a) is disengaged from both the actuator (A) and the other gears of the gear train (7).

Simultaneously, the operating tooth (92) of the emergency lever pushes the second protrusion (46) of the release lever and causes the movement of the release lever (4) in such a way that the side arm (40) of the release lever engages the seat (33) of the pawl and pushes the pawl to the unlocked position where the catch is unlocked.

With reference to FIG. 1, a sixth spring (M6) holds the emergency lever in idle position. Otherwise said, when the emergency lever (9) is actuated, the sixth spring (M6) is loaded, and when the emergency lever is released, the sixth spring is unloaded, returning the emergency lever to the idle position.

With reference to FIG. 9, the closing lever (5) is connected to the quaternary gear (70d). Specifically, the closing lever (5) is pivoted to the lower pin (83) of the quaternary gear and is arranged on the rib (84) of the quaternary gear. The locking lever (5) has an operating end (50) facing the operating arm (25) of the catch.

The closing lever (5) has a pin (51) arranged near its operating end (50). The pin (51) of the locking lever engages and slides in a groove formed on the base plate (10) of the box.

The rib (84) of the quaternary gear (70d) is used to hold the closing lever (5) in place in order to prevent its pin (51) from leaving the groove located on the base plate (10) of the box.

Returning to FIG. 1, the lock (100) may comprise position detection means (S1, S2, S3) arranged in the box (1) to detect the position of the catch (2) and/or the pawl (3).

Moreover, the lock (100) may comprise an electrical connector (C) arranged in the box (1) to connect the electrical parts of the lock, i.e., the position detection means (S1, S2, S3) and the electric motor (6) of the actuator.

The operation of the lock (100) is described below.

With reference to FIG. 10, the lock is closed, i.e., the stop tooth (32) of the pawl is in contact with the stop tooth (23) of the catch in order to lock the catch (2) in closing position.

In such a situation with the lock closed, the side arm (40) of the release lever (4) is near the seat (33) of the pawl.

In order to open the lock, the user operates the actuator (A) which moves the gear train (7). As a result, the tertiary gear (70c) turns in the direction of arrow F1. Then, the stop surface (77b) of the curved seat (77) of the tertiary gear stops against the first protrusion (45) of the release lever and rotates the release lever (4) in the same direction as the tertiary gear.

The side arm (40) of the release lever (4) goes against the seat (33) of the pawl and causes the rotation of the pawl (3) in the direction of arrow F2. In this way, as shown in FIG. 11, the stop tooth (32) of the pawl disengages the stop tooth (23) of the catch; so, the catch (2) is unlocked and can be moved in the direction of arrow F3 in order to open the lock.

FIG. 12 illustrates the situation in which the lock is in an intermediate closing position, wherein the stop tooth (32) of the pawl is engaged in the stop seat (27) of the catch.

In such a situation, in order to obtain a total closing of the lock, the user operates the actuator (A) that causes the rotation of the gear train (7). As a result, the quaternary gear (70d) rotates in the direction of arrow F4.

As shown in FIG. 13, the operating end (50) of the closing lever (5) goes in contact against the operating arm (25) of the catch. The quaternary gear (70d) continues to rotate in the direction of arrow F4. So, the operating end (50) of the locking lever (5) pushes the operating arm (25) of the catch. Consequently, the catch (2) rotates in the direction of arrow F5, and the cam surface (28) of the catch slides on the cam surface (38) of the pawl until the stop tooth (32) of the pawl engages with the stop tooth (23) of the catch, as shown in FIG. 14.

FIG. 14 illustrates the situation in which the lock is closed because the stop tooth (32) of the pawl is engaged with the stop tooth (23) of the catch, so as to prevent the catch from being opened.

The operation of the emergency lever (9) is described below, in case the actuator (A) is broken or the lock is jammed.

With reference to FIG. 15, the emergency lever (9) is in idle position, the inclined plane (91) of the emergency lever is opposite the first toothed wheel (71) of the primary gear, and the operating tooth (92) of the emergency lever is opposite the second protrusion (46) of the release lever.

The user pushes the emergency lever (9) in the direction of arrow E1, so the inclined plane (91) advances under the first toothed wheel (71) of the primary gear and lifts the primary gear (70a), disengaging the first toothed wheel (71) of the primary gear from the worm gear (61) of the actuator and the second toothed wheel (72) of the primary gear from the first toothed wheel (73) of the secondary gear.

Simultaneously, the operating tooth (92) of the emergency lever pushes the second protrusion (46) of the release lever and causes the movement of the release lever (4) in such a way that the side arm (40) of the release lever engages the seat (33) of the pawl and pushes the pawl to the unlocking position where the catch is unlocked.

FIG. 16 illustrates a situation in which the emergency lever (9) is advanced with respect to its initial idle position, then the primary gear (70a) begins to rise under the inclined plane (91) of the emergency lever and the release lever (4) begins to move under the push of the operating tooth (92) of the emergency lever. As a result, the pawl (3) moves in the direction of arrow E2, and the stop tooth (32) of the pawl disengages the stop tooth (23) of the catch.

FIGS. 17, 18, 19 illustrate the situation in which the emergency lever (9) has been operated manually by the operator to an end-of-travel position. In such a situation, the primary gear (70a) is disengaged from the worm gear (61) and from the secondary gear (70b), and the stop tooth (32) of the pawl has disengaged the stop tooth (23) of the catch, unlocking the catch (2) in order to open the lock.

When the user releases the emergency lever (9), the sixth spring (M6) of the emergency lever returns the emergency lever to its initial idle position.

The fourth spring (M4) of the primary gear (70a) lowers the primary gear in such a way that the first toothed wheel (71) of the primary gear engages the worm gear (61) and the second toothed wheel (72) of the primary gear engages the first toothed wheel (73) of the secondary gear (70b).

Equivalent variations and modifications may be made to the present embodiment of the invention, within the scope of a person skilled in the art, while still falling into the scope of the invention as expressed by the appended claims.

1. A vehicle lock comprising:
a box comprising a base plate having a slot suitable for accommodating a striker that is integral with a body part or a hatch of the vehicle;
a catch having a central portion and an engagement seat suitable for engaging the striker when it is in the slot of the base plate, said catch being pivoted to said base plate around a first pivoting pin to go from a closing position, wherein said striker is locked, to an open position, wherein said striker is unlocked;
a pawl suitable for locking said catch in the closing position, said pawl being pivoted to said base plate around a second pivoting pin to go from a locked position, wherein said catch is locked, to an unlocked position, wherein said catch is unlocked;
a release lever suitable for cooperating with said pawl to move it towards the unlocked position in order to bring the catch to the open position;
an actuator moving a gear train configured to move said release lever;
wherein said release lever is in the form of a U-shaped bracket comprising a side arm connected to a lower arm and to an upper arm
wherein the lower arm and the upper arm of the release lever are revolvingly mounted on a first shaft that supports a gear of said gear train that moves said release lever; and
wherein said side arm of the release lever is suitable for engaging with a seat of the pawl to move the pawl towards the unlocked position.

2. The lock of claim 1, wherein said upper arm of the release lever comprises a first protrusion that engages in a curved seat of said gear that moves said release lever.

3. The lock of claim 1, wherein the lower arm and the upper arm of the release lever terminate with respective eyelets that revolvingly engage in said first shaft.

4. The lock of claim 1, comprising an emergency lever operable manually by the user to open the lock, said emergency lever acting simultaneously on a gear to disengage it from the actuator and/or from another gear of the gear train and on said release lever to move the pawl and release the catch.

5. The lock of claim 4, wherein said emergency lever comprises:
an inclined plane arranged in front of a gear of said gear train for lifting said gear and disengaging it from the actuator and/or from another gear of the gear train; and
an operating tooth arranged opposite a second protrusion of the release lever to move said release lever.

6. The lock of claim 1, wherein said actuator comprises a worm gear and said gear train comprises:
a primary gear meshing with the worm gear;
a secondary gear meshing with the primary gear;
a tertiary gear meshing with the secondary gear; and
a quaternary gear meshing with the tertiary gear.

7. The lock of claim 1, comprising a closing lever suitable for cooperating with an operating arm of said catch to move the catch from an intermediate closing position to said closing position, said closing lever being moved by said actuator by means of said gear train.

8. (canceled)

9. The lock of claim 7, wherein said release lever is connected to and operated by said tertiary gear.

10. The lock of claim 7, comprising an emergency lever operable manually by the user to open the lock, said emergency lever acting simultaneously on a gear to disengage it from the actuator and/or from another gear of the gear train and on said release lever to move the pawl and release the catch, wherein said emergency lever operates on said primary gear.

11. The lock of claim 6, comprising a closing lever suitable for cooperating with an operating arm of said catch to move the catch from an intermediate closing position to said closing position, said closing lever being moved by said actuator by means of said gear train.

12. The lock of claim 11, wherein said closing lever is connected to said quaternary gear.
